(19) United States
(12) Patent Application Publication
(10) Pub. No.: US 2016/0034210 A1
(43) Pub. Date: Feb. 4, 2016

(54) COMMITTING DATA ACROSS MULTIPLE, HETEROGENEOUS STORAGE DEVICES

(71) Applicant: International Business Machines Corporation, Armonk, NY (US)

(72) Inventors: Joseph W. Gentile, New Paltz, NY (US); Andrew M. Sica, Oxford, CT (US); Douglas M. Zobre, Poughkeepsie, NY (US)

(21) Appl. No.: 14/448,021

(22) Filed: Jul. 31, 2014

(51) Int. Cl. G06F 3/06; G06F 11/20

(52) U.S. Cl. CPC G06F 3/0619; G06F 11/2069; G06F 11/2058; G06F 3/0689; G06F 3/0665; G06F 2201/84; G06F 2201/855; G06F 2003/0692

(57) ABSTRACT

Embodiments relate to writing data to a plurality of storage devices. A computer-implemented method for writing data to a plurality of storage devices that are represented as a single storage device to exploiters that send requests to write data to the single storage device is provided. The method receives a request to write data to the single storage device. The method reserves a space in a secondary storage device. The method writes the data to a primary storage device after the space in the secondary storage device is successfully reserved. The method writes the data to the reserved space in the secondary storage device after the writing the data to the primary storage device is successfully completed.

### BACKGROUND

The present invention relates generally to committing data to storage, and more specifically, to committing data across heterogeneous storage devices.

A conventional system for storing data may use more than one storage medium to store data. Typically, one storage medium serves as a primary storage medium and another storage medium serves as a secondary storage medium, which backs up the primary storage medium. The conventional system stores data to the primary storage medium and mirrors or replicates the data from the primary storage medium to the secondary storage medium. The primary storage medium and the secondary storage medium usually are homogeneous in that the sizes and/or the types of the storage medium are similar or identical.

### SUMMARY

Embodiments include a computer program product, a method, and a system for committing data to a plurality of heterogeneous storage media. According to an embodiment of the present invention, a computer program product for writing data to a plurality of storage devices that are represented as a single storage device to exploiters that send requests to write data to the single storage device is provided. The computer program product comprises a computer readable storage medium having program instructions embodied therewith. The program instructions readable by a processing circuit cause the processing circuit to perform a method. The method receives a request to write data to the single storage device. The method reserves a space in a secondary storage device. The method writes the data to a primary storage device after the space in the secondary storage device is successfully reserved. The method writes the data to the reserved space in the secondary storage device after the writing the data to the primary storage device is successfully completed.

According to another embodiment of the present invention, a computer-implemented method for writing data to a plurality of storage devices that are represented as a single storage device to exploiters that send requests to write data to the single storage device is provided. The method receives a request to write data to the single storage device. The method reserves a space in a secondary storage device. The method writes the data to a primary storage device after the space in the secondary storage device is successfully reserved. The method writes the data to the reserved space in the secondary storage device after the writing the data to the primary storage device is successfully completed.

According to a further embodiment of the present invention, a computer system for writing data to a plurality of storage devices that are represented as a single storage device to exploiters that send requests to write data to the single storage device is provided. The computer system comprises a memory having computer readable instructions and a processor configured to execute the computer readable instructions. The instructions are executed to perform a method. The method receives a request to write data to the single storage device. The method reserves a space in a secondary storage device. The method writes the data to a primary storage device after the space in the secondary storage device is successfully reserved. The method writes the data to the reserved space in the secondary storage device after the writing the data to the primary storage device is successfully completed.

### BRIEF DESCRIPTION OF THE SEVERAL VIEWS OF THE DRAWINGS

The subject matter which is regarded as embodiments is particularly pointed out and distinctly claimed in the claims at the conclusion of the specification. The forgoing and other features, and advantages of the embodiments are apparent from the following detailed description taken in conjunction with the accompanying drawings in which:

FIG. 1 depicts a block diagram of a data writing system according to an embodiment of the invention; and

FIG. 2 depicts a process flow for writing data to storage mediums according to an embodiment of the invention.

### DETAILED DESCRIPTION

In some embodiments, a data writing system manages a plurality of storage devices that appear as a single storage device to the exploiters that request the data writing system to write data to the single storage device. The exploiters may be computer programs or devices that utilize the single storage device to store and retrieve data by sending requests to the data writing system. The plurality of storage devices include a primary storage device to which the data writing system writes data first and a secondary storage device to which the data writing system writes the same data after writing the data to the primary storage device for data recovery purposes. That is, the data writing system duplexes the data to the primary storage device and the secondary device rather than replicating or mirroring the data from the primary storage device to the secondary device. Because the data is duplexed rather than being replicated or mirrored, the primary storage device and the secondary storage device do not have to be homogeneous, which is a requirement for data replication or mirroring. In some embodiments, the primary storage device and the secondary storage devices are heterogeneous in that these two devices have different storage capacity (i.e., sizes), are of different types (e.g., random access memory (RAM) drives vs. tape drives), or are managed by different storage-management software.

A plurality of exploiters (e.g., computer programs) may share the single storage device to perform various data operations (e.g., read, write, modify, delete, etc.). Typically, the exploiters send requests (e.g., via application programming interface (API)) to the data writing system to have the data writing system to perform these data operations. The data writing system handles these requests in parallel.

When an exploiter sends a request to write a piece of data to the single storage device, the data writing system of some embodiments first writes the data to the primary storage device and then immediately writes the same data to the secondary storage device for an immediate recoverability of the data. In some cases, the data writing system cannot change the order in which the data is written (i.e., first to the primary storage device and then to the secondary storage device) for different reasons. For instance, the primary storage device may provide a unique identifier or index for the data, which is required for the second storage device, or the primary storage device may have better resiliency points than the secondary storage device. After the data is successfully written to both the primary and secondary storage devices, the data writing system returns a message that indicates a successful writing to the single storage device to the exploiter that sent the request to the data writing system.

When the data is successfully written to the primary storage device but not to the secondary storage device because, for example, the secondary storage device runs out of space to write more data, the data writing system returns a message that indicates a failure to write to the single storage device to the exploiter that sent the request to the data writing system. In some embodiments, the exploiter then sends another request to write the same data to the data writing system, anticipating that the secondary storage device would clear up some space to store the data. If, however, the secondary storage device does not clear enough space to write the data soon, the same data may end up being written to the primary storage device multiple times. There is no definitive way to determine in advance whether the secondary storage device will run out of space because the writing operations for different write requests from different exploiters take different amounts of time to complete. Moreover, it is not desirable or possible to back out the data written to the primary storage device because the data written to the primary storage device becomes available for being read or used by the exploiters. Furthermore, because the data written to the primary storage device is available for being read by the exploiters, the data that has written to the primary storage device but not to the secondary storage device will not be recoverable to the exploiters that read and used the data in case the primary storage device fails. This is then considered a failure for the data writing system to meet a performance goal (e.g., being a high availability (HA) system).

The data writing system of some embodiments of the invention reserves a space in the secondary storage system for writing data before writing the data to the primary storage device. The data writing system writes the data to the primary storage device first and then writes the same data in the reserved space of the secondary storage device. Thereby, the data writing system avoids those cases in which data is written successfully to the primary storage device but not to the secondary storage device.

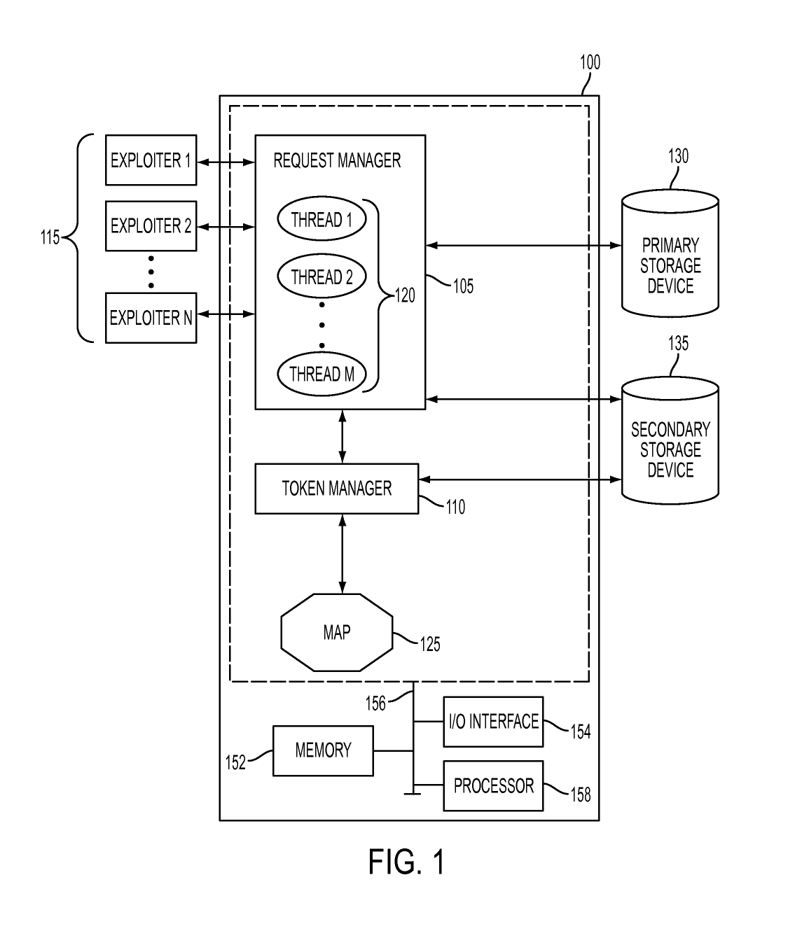

FIG. 1 illustrates an exemplary data writing system 100 in accordance with some embodiments of the invention. The data writing system of some embodiments includes one or more modules or sub-modules such as a request manager 105 and a token manager 110. FIG. 1 also illustrates a plurality of exploiters 115, a primary storage device 130 and a secondary storage device 135.

In some embodiments, the exploiters 115 are computer programs that execute in the same physical or virtual machine or in different physical or virtual machines running the same or different operating systems. In some cases, at least one or all of the exploiters 115 may also execute in the same physical machine in which the data writing system 100 operates. For instance, the exploiters 115 and the data writing system 100 run in a mainframe computer or in a cluster of mainframe computers (e.g., in IBM™ Parallel Sysplex). The exploiters 115 send requests to write or read data to the data writing system 100. In some embodiments, the requests are API calls that the data writing system supports.

The exploiters 115 share a single storage device (not shown) that is provided by the data writing system 100. The data writing system 100 provides this single storage device that represents the primary storage device 130 and the secondary storage device 135. The implementations and operations of this single storage device are transparent to the exploiters 115. That is, the data writing system 100 presents this single storage device as a “black box” storage entity which may be shared (i.e., connected, written to, read from, etc.) by the exploiters 115. The data writing system 100 responses to a request with a binary message that indicates either a success or a failure to complete the given request.

The request manager 105 of the data writing system 100 receives the requests from the exploiters 115, performs read or write operations on the primary and secondary storage devices 130 and 135, and sends success or failure messages to the exploiters 115 based on the results of the performed operations. Specifically, in some embodiments, the request manager 105 spawns one or more threads that perform the read or write operations according to each request. Threads 120 shown in the request manager 105 perform read or write operations for the requests received from the exploiters 115.

A thread may perform an operation to write a piece of data specified by a write request to the single storage device. The write thread first reserves a space in the secondary storage device 135 so that other write threads may not write data to the reserved space. Specifically, in some embodiments, the write thread communicates with the token manager 110 to obtain a token that represents a space in the secondary storage device 135. This token defines a location and boundaries of the reserved space in the secondary storage device. In some embodiments, a token-obtaining operation is serialized (e.g., compare and swap) so as to ensure the space is reserved by only one thread.

If a token is unsuccessfully obtained (e.g., a failure to obtain the token), the request manager 105 returns a message indicating the write request has failed to be completed (i.e., the data was unsuccessfully written to the single storage device) to the exploiter that sent the write request to the request manager 105. If a token is successfully obtained, the write thread writes the data to the primary storage device 130. If the data is successfully written to the primary storage device 130, the write thread then writes the same data to the reserved space of the secondary storage device 135. If the data is unsuccessfully written to the primary storage device 130 (e.g., if writing the data to the primary storage device 130 fails), the write thread releases the token so that reserved space is freed and available for other threads to write data and the request manager 105 returns a message indicating the write request has failed to be completed.

In some embodiments, the token manager 110 manages a map 125, which represents the secondary storage device 135. That is, the map 125 includes location and boundary information for each storage space in the secondary storage device 135. The map 125 is accessible by all of the threads 120 of the request manager 105. However, the operation to obtain a token is serialized so that a space may be reserved by only one thread. The threads 120 use the location and boundary information to perform read or write operations to the secondary storage device 135.

In some embodiments, the primary storage device 130 and the secondary storage devices 135 are heterogeneous in that the two devices have different storage capacity or are of different types. Moreover, the primary storage device 130 is faster than the secondary storage device 135 in terms of input and output (I/O) speeds. An example type of the primary storage device 130 is IBM's Coupling Facility (CF) list structure. An example type of the secondary storage device 135 is IBM's Direct Access Storage Device (DASD), in which each physical record (i.e., a space) has a discrete location and a unique address.

As used herein, the terms module and sub-module may refer to an application specific integrated circuit, an electronic circuit, a processor (shared, dedicated, or group) and memory that executes one or more software or firmware programs, or a combinational logic circuit in a server. For example, in some embodiments, the request manager 105 may be communicatively connected (e.g., through a bus 156) to a memory 152 to store and retrieve requests from the exploiters 115, and to an I/O interface 154 to access or retrieve data stored in the primary and secondary storage devices 130 and 135. The request manager 105 may also use a processor 158 to perform its read, write, or other operations. Moreover, the token manager may maintain the map 125 in the memory 152 as an “in-memory map” representation of the secondary storage device 135. In some embodiments, the modules of the data writing system 100, namely the request manager 105 and the token manager 110 may be combined or further partitioned. Also, the modules of the data writing system 100 may be implemented in more than one physical machine in a distributed fashion.

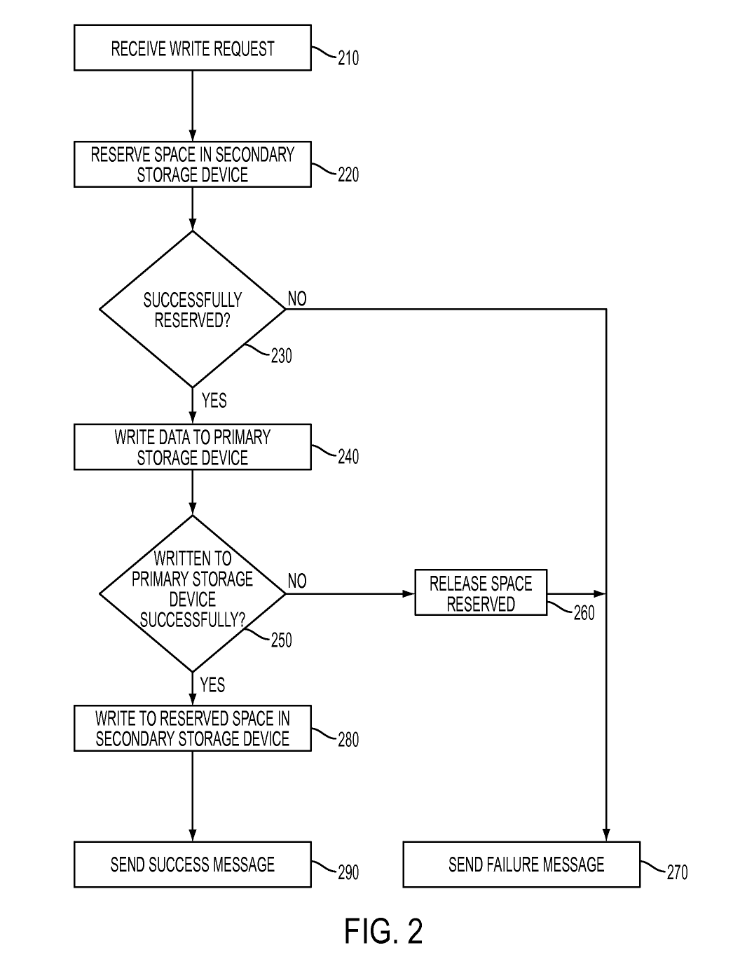

FIG. 2 depicts a process flow (e.g., a method) for writing data to a plurality of heterogeneous storage devices in accordance with some embodiments of the invention. In some embodiments, the data writing system 100 of FIG. 1 performs the process flow shown in FIG. 2.

At block 210, the data writing system 100 receives a request to write data to a single storage device representing a plurality of storage devices, from an exploiter. In some embodiments, the exploiter is a computer application executing in the same physical machines in which the data writing system 100 operates or in other physical machines.

The plurality of storage devices includes the primary storage device 130 and the secondary storage device 135 of FIG. 1, which, in some embodiments, are heterogeneous. Moreover, the primary storage device 130 is faster than the secondary storage device 135 in writing data.

At block 220, the data writing system 100 reserves a space in the secondary storage device 135. The data writing system 100 maintains the map 125 that represents the secondary storage device 135 and utilizes the map 125 to reserve a space in the secondary storage device 135. In some embodiments, the data writing system 100 utilizes a token that represents the space in the secondary storage device 135 in order to reserve or release the space.

At block 230, the data writing system 100 determines whether the space in the secondary storage device 135 is successfully reserved at block 220. If the space is unsuccessfully reserved (e.g., when the reservation of the space fails), the data writing system 100 proceeds to block 270 to send a message that indicates a failure to write to the single storage device to the exploiter from which the request is received at block 210. If the space is successfully reserved, the data writing system writes at block 240 the data to the primary storage device 130.

At block 250, the data writing system 100 determines whether the data is written to the primary storage device 130 successfully. If the data is not written to the primary storage device successfully, the data writing system 100 releases at block 260 the reserved space in the secondary storage device and sends a message indicating a failure to write the data to the single storage device to the exploiter from which the request is received at block 210.

At block 280, the data writing system 100 writes the data to the reserved space in the secondary storage device after the writing the data to the primary storage device is successfully completed. At block 290, the data writing system 100 sends a message indicating a successful writing of the data to the single storage device after writing the data to the secondary storage device.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission medium (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer program product for writing data to a plurality of storage devices that are represented as a single storage device to exploiters that send requests to write data to the single storage device, the computer program product comprising:
a computer readable storage medium having program instructions embodied therewith, the program instructions readable by a processing circuit to cause the processing circuit to perform a method comprising:
receiving a request to write data to the single storage device;
reserving a space in a secondary storage device;
writing the data to a primary storage device after the space in the secondary storage device is successfully reserved; and
writing the data to the reserved space in the secondary storage device after the writing the data to the primary storage device is successfully completed.

2. The computer program product of claim 1, wherein the method further comprises sending a message indicating a failure to write the data to the single storage device to an exploiter from which the request is received after a failure to reserve a space in the secondary storage device.

3. The computer program product of claim 1, wherein the method further comprises, when the writing the data to the primary storage device is unsuccessful:
releasing the reserved space in the secondary storage device; and
sending a message indicating a failure to write the data to the single storage device to an exploiter from which the request is received.

4. The computer program product of claim 1, wherein the method further comprises sending a message indicating a successful writing of the data to the single storage device after writing the data to the secondary storage device.

5. The computer program product of claim 1, wherein the primary storage device and the secondary storage device are heterogeneous.

6. The computer program product of claim 1, wherein the method further comprises:
maintaining a map that represents the secondary storage device; and
utilizing the map to reserve a space in the secondary storage device.

7. The computer program product of claim 1, wherein the method further comprises utilizing a token that represents the space in the secondary storage device in order to reserve or release the space.

8. The computer program product of claim 1, wherein an exploiter is a computer application executing in the computer or in another computer.

9. The computer program product of claim 1, wherein the primary storage device is faster than the secondary storage device in writing data.

10. A computer-implemented method for writing data to a plurality of storage devices that are represented as a single storage device to exploiters that send requests to write data to the single storage device, comprising:
receiving a request to write data to the single storage device;
reserving, by a computer, a space in a secondary storage device;
writing the data to a primary storage device after the space in the secondary storage device is successfully reserved; and
writing the data to the reserved space in the secondary storage device after the writing the data to the primary storage device is successfully completed.

11. The method of claim 10, further comprising sending a message indicating a failure to write the data to the single storage device to an exploiter from which the request is received after a failure to reserve a space in the secondary storage device.

12. The method of claim 10, further comprising, when the writing the data to the primary storage device is unsuccessful:
releasing the reserved space in the secondary storage device; and
sending a message indicating a failure to write the data to the single storage device to an exploiter from which the request is received.

13. The method of claim 10, further comprising sending a message indicating a successful writing of the data to the single storage device after writing the data to the secondary storage device.

14. The method of claim 10, wherein the primary storage device and the secondary storage device are heterogeneous.

15. The method of claim 10, further comprising:
maintaining a map that represents the secondary storage device; and
utilizing the map to reserve a space in the secondary storage device.

16. A computer system for writing data to a plurality of storage devices that are represented as a single storage device to exploiters that send requests to write data to the single storage device, the system comprising:
a memory having computer readable instructions; and
a processor configured to execute the computer readable instructions, the instructions executed to perform a method comprising:
receiving a request to write data to the single storage device;
reserving a space in a secondary storage device;
writing the data to a primary storage device after the space in the secondary storage device is successfully reserved; and
writing the data to the reserved space in the secondary storage device after the writing the data to the primary storage device is successfully completed.

17. The computer system of claim 16, wherein the method further comprises sending a message indicating a failure to write the data to the single storage device to an exploiter from which the request is received after a failure to reserve a space in the secondary storage device.

18. The computer system of claim 16, wherein the method further comprises, when the writing the data to the primary storage device is unsuccessful:
releasing the reserved space in the secondary storage device; and
sending a message indicating a failure to write the data to the single storage device to an exploiter from which the request is received.

19. The computer system of claim 16, wherein the method further comprises sending a message indicating a successful writing of the data to the single storage device after writing the data to the secondary storage device.

20. The computer system of claim 16, wherein the primary storage device and the secondary storage device are heterogeneous.
